(19) United States
(12) Patent Application Publication
(10) Pub. No.: US 2008/0077581 A1
(43) Pub. Date: Mar. 27, 2008

(54) SYSTEM AND METHOD FOR PROVIDING MEDICAL DISPOSITION SENSITIVE CONTENT

(76) Inventors: Jay Drayer, Houston, TX (US); Grant M. Howe, Cypress, TX (US)

Correspondence Address: FULBRIGHT & JAWORSKI, LLP, 1301 MCKINNEY, SUITE 5100, HOUSTON, TX, 77010-3095, US

(21) Appl. No.: 11/861,068

(22) Filed: Sep. 25, 2007

Related U.S. Application Data
(60) Provisional application No. 60/826,856, filed on Sep. 25, 2006.

(51) Int. Cl. G06F 17/30

(52) U.S. Cl. 707/5; 707/E17.014

(57) ABSTRACT

A system and method operable to collect user created content uploaded to an online community, including uniform codes and terms, and determine a category of related content that the user is most likely to be interested in. Embodiments of the system and method are particularly adapted to systematically parse and compare user created content and diagnostic codes linked to such content to a database of search terms, weighting the matched terms, and assigning at least one most relevant medical sensitive disposition category to a user profile to provide relevant advertising and topic content.

### CROSS-REFERENCE TO RELATED APPLICATIONS

This application claims the benefit of U.S. Provisional Application Ser. No. 60/826,856 filed Sep. 25, 2006, the contents of which are hereby incorporated by reference in their entirety.

### TECHNICAL FIELD

At least one aspect of this invention relates to a system and method for providing web content based upon a plurality of user inputs. More particularly, at least one aspect of the invention relates to determining relevant topical and advertising content based upon user created content including uniform diagnostic codes, keywords, and combinations of same.

### BACKGROUND OF THE INVENTION

Consumers of content and providers of content generally only connect through unfocused and labor intensive means. Consumers tend to focus on large searches that must be repeatedly refined in scope until the consumer has found the general group of related content that they were looking for. Searches of web pages using keywords, for example, often return an over abundance of search results, most of which are not relevant to the user. At the same time, providers are forced to broadcast their content to large groupings of consumers where only a small subset of the consumer group is interested in the content. In many scenarios, providers miss their target audience altogether because their technology matches keywords with advertisements that are irrelevant to the user. Accordingly, both sides must invest significant time and expense to connect in a way that is meaningful and productive.

As consumers and providers continue to try to connect in meaningful ways, online forums, such as social networking and web log (“blogs”) communities, have emerged as an efficient means to exchange content. In this context, providers demonstrate particular interest in online forums having a large user base, where each user's interests are known. Specific knowledge of the users' interests arm providers with information needed to deliver relevant topical and advertising content. Although consumers often provide much of the content that makes up online forums, providers have and continue to ineffectively identify and respond to the unique interests of consumers.

Highly specialized consumer interests prove particularly challenging to match with relevant content. At the same time, these consumers, characterized by a narrow scope of interest, represent a highly profitable target audience for providers. For example, healthcare consumers often direct their interests toward hospitals, insurance, and a vast collection of specialized private and not-for-profit groups. However, these and other healthcare system participants, competing in an important economic sector, continue to miss their target online consumers using the prior art.

There is therefore a long felt and unsatisfied need for an enhanced system and method for providing relevant content online, and particularly for consumers of specialized content such as healthcare.

### BRIEF SUMMARY OF THE INVENTION

The disclosure herein provides a framework that receives user created content, including medical diagnosis codes, medical key words, web blog entries, calendar appointments, bulletin board postings, etc., and matches a certain category of healthcare related content that the user is most likely to be interested in. This greatly narrows the search effort for content and provides focused and relevant advertisement to consumers. This further provides a smaller broadcast area of interested consumers to providers of healthcare related content.

User posted content and data is systematically parsed and compared to a database of keywords or search terms which are associated with a particular disposition category. Positive matches to keywords are assigned a particular score based on a weighting for that keyword or group of keywords and are totaled into a final score as well as a prioritization and/or weighting of multiple scores for each disposition category. If the total score is equal to or above a set threshold, the user is assigned that disposition category. A user may be assigned more than one disposition category. As the user creates more content and data input, the system continually evaluates the received user-input and updates the user's assigned disposition categories.

Content in the user interface is then selected and presented to the user based on the user's disposition categories, which includes one or more healthcare related advertisements and/or topical information. The content provided to the user includes links, articles, special offers, invitations to join groups, etc.

The system and method perform the following: User creates content in on online system (online community, registration, web blogs, calendar appointments, bulletin board entries, search terms, etc.) A disposition engine, tuned specifically to look for healthcare-related terms (or another subject matter), industry codes and classifications and cues, compares keywords, codes, activity, affinity, etc. entered by or collected from the user to words stored in a keyword repository. A disposition engine determines a weighting for matched keywords, and creates a user profile representing each relevant disposition categories. A content generation engine develops a prioritized list of high-weighted healthcare topic and advertisement related content areas that the consumer is likely to be interested in based on the user profile, organizing the content according system priorities. The consumer is automatically presented with customized and focused links, content, streaming media, advertising, options, etc. based on the user profile and system priorities. The analysis can be continually run as the user provides more input to the system so that the content delivered becomes even more relevant and refined as the system is used. Reporting is available to provide details such as the size of the healthcare related groups' membership as well as other market demographics related to the group.

Although the system and method described herein are set forth within the context of healthcare and medical content, the system and method are applicable to the provision and processing of other types of content. For example, a news content provider may employ the present system and method to receive user's input and determine that the user is most interested in fitness, and especially interested in information related to exercise, for example. The content and advertisement delivered to the user may then be more focused on the user's assigned group, in this instance fitness and exercise, for example.

Accordingly, one embodiment comprises: a scraper process operable to receive and continually receive user-input and determine matches to words stored in a keyword repository, a weighting process operable to determine a weighting for each matched word and generate a prioritized list of weighted words, and a categorization process operable to match the weighted words in the prioritized list to a plurality of dispositions categories and determine at least one most relevant disposition category.

A further embodiment comprises: a content selection process operable to select topic and advertising in response to the determined at least one most relevant disposition, a content prioritization process operable to sort the selected topic and advertising by weighting, and a content packager operable to generate a topic file and an advertising file in response to the prioritized topic and advertising.

Another embodiment includes user-input comprising at least one uniform code or uniform term, in which the uniform code or uniform term is optionally a medical diagnostic code or medical term.

Another embodiment includes user-input supplied to an online community, in which the online community is organized according to healthcare related circumstances. In this context, the weighting process is optionally based at least in part upon the context of the user-input within the online community, where the context of the user-input optionally includes the relative ordering of at least two of the matched words.

Another embodiment includes disposition categories comprising a set of uniform codes or uniform terms stored in the keyword repository.

Another embodiment comprises: receiving user-input and determining matches to words stored in a keyword repository, determining a weighting for each matched word and generating a prioritized list of weighted words, matching the weighted words in the prioritized list to a plurality of disposition categories and determining at least one most relevant disposition category, selecting topic and advertising in response to the determined at least one most relevant disposition category, sorting the selected topic and advertising by weighting, and generating a topic file and an advertising file in response to the prioritized topic and advertising.

Another embodiment includes receiving at least one uniform code or uniform term, in which at least one uniform code or uniform term optionally comprises receiving at least one medical diagnostic code or medical term.

Another embodiment comprises determining at least one most relevant disposition category by matching at least one received diagnostic code or medical term stored within the most relevant disposition category with at least one word stored in the keyword repository.

Another embodiment comprises selecting topic and advertising by selecting at least one healthcare related topic and advertising.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

### BRIEF DESCRIPTION OF THE DRAWINGS

FIG. 1 is a simplified block diagram of a disposition engine according to an embodiment of the system for providing medical disposition sensitive content;

FIG. 2 is a simplified block diagram of a content generation engine according to an embodiment of the system for providing medical disposition sensitive content;

FIG. 3 is a flowchart of a scraper process according to an embodiment of the system for providing medical disposition sensitive content;

FIG. 4 is a flowchart of a weighting process according to an embodiment of the system for providing medical disposition sensitive content;

FIG. 5 is a flowchart of a categorization process according to an embodiment of the system for providing medical disposition sensitive content;

FIG. 6 is a flowchart of a content selection process according to an embodiment of the system for providing medical disposition sensitive content;

FIG. 7 is a flowchart of a content prioritization process according to an embodiment of the system for providing medical disposition sensitive content; and

FIG. 8 is a flowchart of a content packaging process according to an embodiment of the system for providing medical disposition sensitive content.

### DETAILED DESCRIPTION OF THE INVENTION

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. It is also understood that, for purposes of clarity, like reference numerals identify like elements, structures or processes in each of the figures. The framework disclosed herebelow is preferably implemented by a computer executable program or hardware, according to practices known to those of ordinary skill in the art.

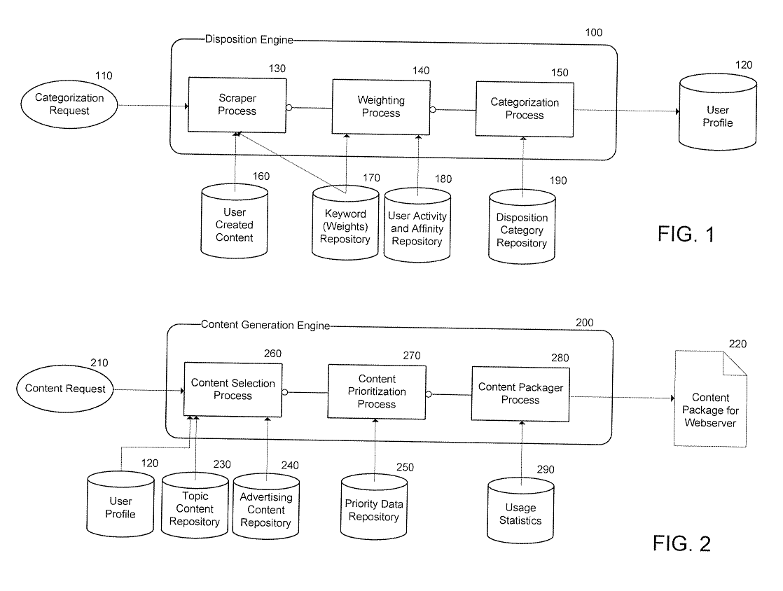

The framework disclosed herebelow addresses shortcomings of present online forums by providing a means to accurately identifying and capture users' interests. To do so, the disposition engine 100 of FIG. 1 executes processes for collecting and analyzing information, supplied by each user over an online forum, to create a unique user profile 120. Based upon the user profile 120, the content generation engine 200 of FIG. 2 selects and prioritizes relevant content for presentation to the user.

As shown in FIG. 1, a categorization request 110 starts the disposition engine 100. The categorization request 110 is a process operable to selectively or automatically invoke other processes in the disposition engine. Administrators issue the categorization request 110 or set up automatic batch processing to do so. The content request 110 also preferably executes in response content updates by the user. To optimize processing resources, the content request 110 executes, and the disposition engine runs, during off peak times when computing resources are less busy. Computationally expensive processes of the disposition engine 100 preferably execute when user traffic in the online forum is low, for example.

The disposition engine 100 preferably includes at least one scraper process 130, weighting process 140, and categorization process 150. These processes preferably execute in sequence. However, one or more computers, communicating with each other over a network, execute the processes simultaneously or in parallel in alternative embodiments. Together, the processes operate to collect and analyze user created content 160 and provide a unique user profile 120 as disclosed below.

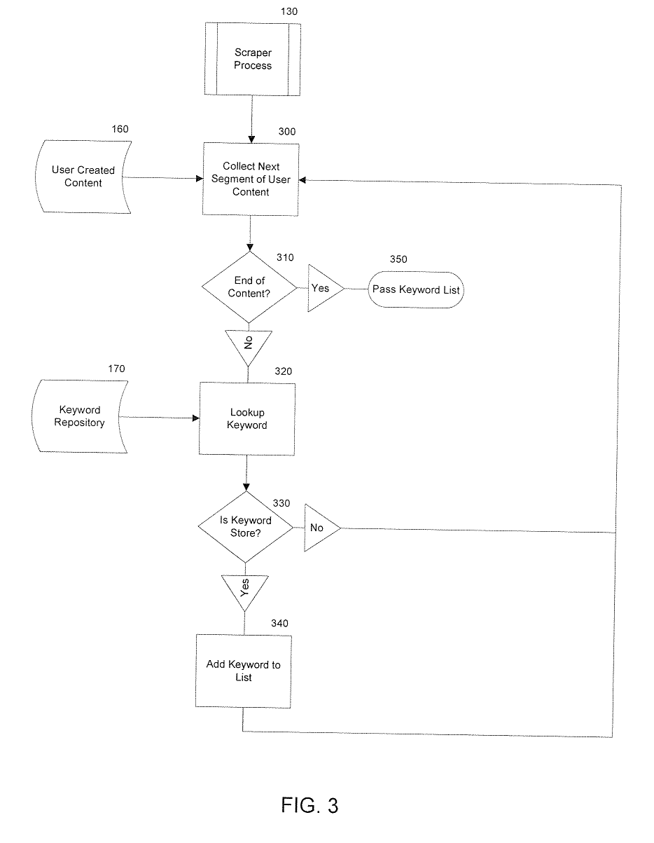

The scraper process 130 collects user created content 160 from at least one source and compares such content to search terms, including keywords and other information, stored in a keyword repository 170 to determine if there is match (See FIG. 3). Once matched, the scraper process 130 forwards the content and matched keywords from the keyword repository 170 to the weighting process 140 for further processing.

In collecting user created content 160, the scraper process 130 reviews information from a plurality of sources. In the preferred embodiment, the scraper process 130 collects user created content 160 from an online community. Such communities are typically organized according to medical, scientific, social, political or commercial interests, for example.

In the preferred embodiment, the online community is organized around healthcare related circumstances. In this context, a plurality of users create content, usually when forming and updating their own private or public online communities to communicate about their own healthcare related circumstances, or those of family and friends. Through form templates on a web browser, the users provide information such as the name of the community, name of the patient, medical terminology, conditions, and diseases, for example. For convenience to the user, the templates preferably include various text fields, drop down selections, and fields to upload materials. The input templates link with a repository for storing the user created content 160.

User created content 160 includes any data created or supplied by the user to the online community. Within the online community, such data may exist in chat rooms, instant messages, emails, videos, voice chat forums, shared files, blogs, discussion groups, and so on. In alternative embodiments, only user created content 160 meeting predetermined criteria is collected by the scraper process 130. In still further embodiments, the scraper process 130 gathers user created content 160 not uploaded to the online community, such as content on the user's local display, storage mediums, or area network for example.

One or more agent processes, installed anywhere in the network and operable with known means, execute reviews, extractions, and transmissions of the user content 160 to the disposition engine 100 or outside systems for further processing. The scraper process 130 thus resides on the administrator computer, the user computer, or elsewhere. For transmission and reception of user created content 160 over the network, the scraper process 130 preferably utilizes known protocols, such as HTTP.

The scraper process 130 is operable to organize the content into a variety of representative search terms, including keywords, phrases, and a combination of the same, according to verbal and social contexts of the content captured by the scraper process 130. Search terms provide input to the scraper process 130 for natural language and other queries to the keyword repository 170. Accordingly, the scraper process 130 is operable to compare the search terms to records or data stored in the keyword repository 170, as further described in FIG. 3. Matches between search terms and data in the keyword repository 160 forward to the weighting process 140 for additional processing.

Shown in FIG. 1, the keyword repository 170 is preferably a digital storage medium adapted with a database of a known sort, having a structured collection of records for storage of keywords and other data. As with known databases, the stored records and data preferably include an indexing means to enable faster queries. Search term queries by the scraper process 130 provide access to data stored in the keyword repository 170.

Keywords include one or more words, combination of words, or a concepts with special significance, which are relevant to the organization and premise of the online community. Keywords thus relate to financial needs, special interests, advocacy programs, providers, for example. In the preferred embodiment, keywords relate to healthcare or medical dispositions describing a specific tendency, toward a disease, condition, or disorder.

Records in the keyword repository 170 also preferably include indicia for locating uniform codes and uniform terminology, such as an index or data structure. In the preferred embodiment, uniform codes and terminology have applications in healthcare for medical classifications or coding. Without loss of generality, uniform codes and terminology preferably identify specific diseases, disorders, symptoms, medical signs, abnormal findings, complaints, social circumstances, external causes of injury or disease, and measure morbidity and mortality, for example.

Uniform codes may include those from the World Health Organization, such as the International Classification of Diseases (“ICD”), for example. One example ICD code is ICD-11, however the preferred embodiment incorporates several ICD versions. Codes published by the American Psychiatric Association's (“APA”) and Diagnostic and Statistical Manual of Mental Disorders (“DSM”), also preferably link to records in the keyword repository 160. The American Medical Association for Current Procedural Terminology (“CPT”), the Diagnosis-Related Group (“DRG”) for hospital cases, hospital emergency codes, and classifications for the International Classification of Primary Care (“ICPC”) provide further examples of linked information. Uniform terminology includes words, phrases, terms of art, etc, such as medical terminology from sources such as the Medical Dictionary for Regulatory Activities (“MedDRA”).

In alternative embodiments, the keyword repository 170 also includes records storing non-healthcare related uniform codes. The Universal Product Code (“UPC”), Global Trade Item Number (“GTIN”), and zip codes provide further examples of codes organized and analyzed by the disposition engine 100.

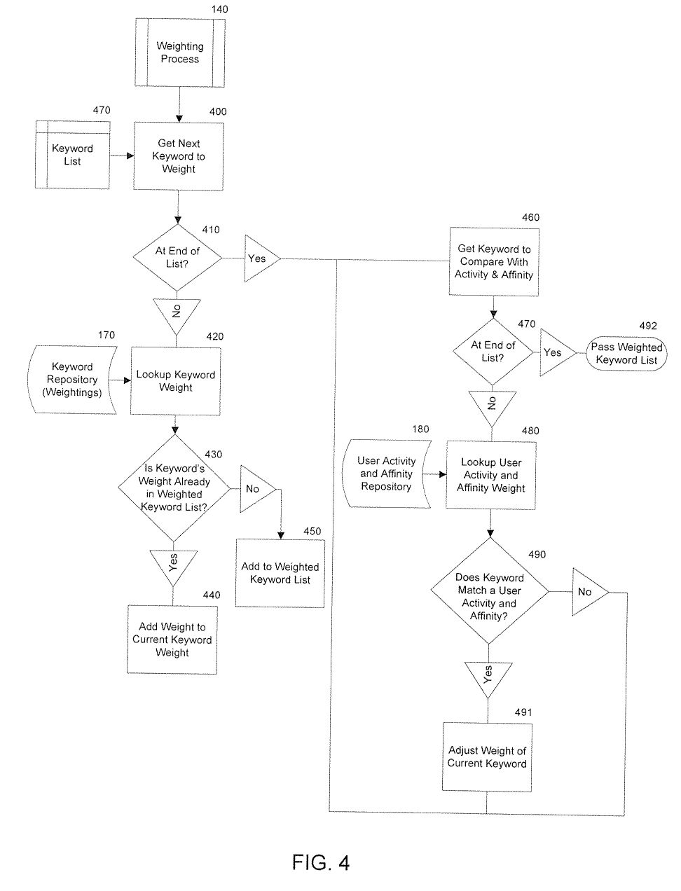

By linking uniform code sets and terminology to records in the keyword repository 170, the disposition engine 100 discerns highly specific information about the user. Such information includes relevant medical services and procedures, healthcare providers, similarly situated patients, accreditation organizations, and payers for administrative, financial services, religious topics, products, and localities among others. To do so, the weighting process 140 first determines a weight for each matched keyword (See FIG. 4).

Weights are specific units of measurement for each keyword stored or linked to keyword repository 170. Higher weights preferably identify keywords having greater importance than those of lower weights. For accuracy, a process dynamically determines keyword weights. Administrators also determine weights, or provide inputs for a system process to do so.

One or more data structures maintains an aggregate score for each matched keyword. As keywords process, the aggregate score adjusts up and down based upon a plurality of weighting factors. In the preferred embodiment, weighting factors include the number of occurrences of a repeated keyword in user created content 160, existence of linked uniform codes and terminology, amount paid by advertisers per click for a given keyword, proximity of user content to matched keyword, and the quality of ads for a given click, for example.

User activities and affinities provide additional weighting factors to the weighting process 140, causing the keyword score to adjust. Both online and offline actions and interests of the user make up the user activities and affinities. To that end, user activities include any pursuits of the user including memberships to other online forums or websites, extracurricular activities, recreations, memberships and participation organized groups, and personal or educational experiences, for example. User affinities include the user's particular likings or habits including, by way of example, web sites visited, spending, gifts received, foods, manner of exercise, chemical substances, as well as geographic, religious, and economic preferences, for example. In the preferred embodiment, a user's membership in several prostate cancer related websites factor to increase the weighting of a representative keyword, for example.

Shown in FIG. 1, user activities and affinities are preferably stored in the user activity and affinity repository 180. The user activity and affinity repository is preferably a digital storage medium operable with a database of a known sort. Administrators, third parties, or system processes preferably provide the user activities and affinities for storage.

As the weighting process 140 executes, it determines if the weighting factors should positively or negatively effect the aggregate score for a given keyword. Positive weighting factors increase the keyword's aggregate score, while negative weighting factors decrease the keyword's total score.

Aggregate keyword scores tally to organize an ordered list for processing by the categorization process 150. The categorization process 150 is operable to identify at least one most relevant disposition category stored in the disposition category repository 190. FIG. 1 shows the disposition category repository 190, which stores each of the disposition categories. The disposition category repository 190 is preferably a digital storage medium operable with a database of a known sort.

In a searchable form, disposition categories comprise a plurality of distinct classes of data, providing the means to organize a person or group of people based on broad or narrow criteria. In the preferred embodiment, disposition categories include information about a user's susceptibility toward specific thoughts or actions. For example, a given disposition category includes a set of keywords. In further embodiments, sets of healthcare related keywords make up the disposition categories, such that a given disposition category comprises one or more of the above mentioned uniform diagnostic codes and/or uniform medical terms, for example. In still further embodiments, the disposition categories 190 are made up of groups of other data types of stored in the keyword repository 170. Medical condition, financial needs, special interests, diet, obesity, enlarged prostate, enlarged prostate non-cancer, proton therapy, dialysis provide example disposition categories 190 stored in the disposition category repository 190. For revenue purposes, disposition categories are prioritized according to price, profit margin and click-frequency.

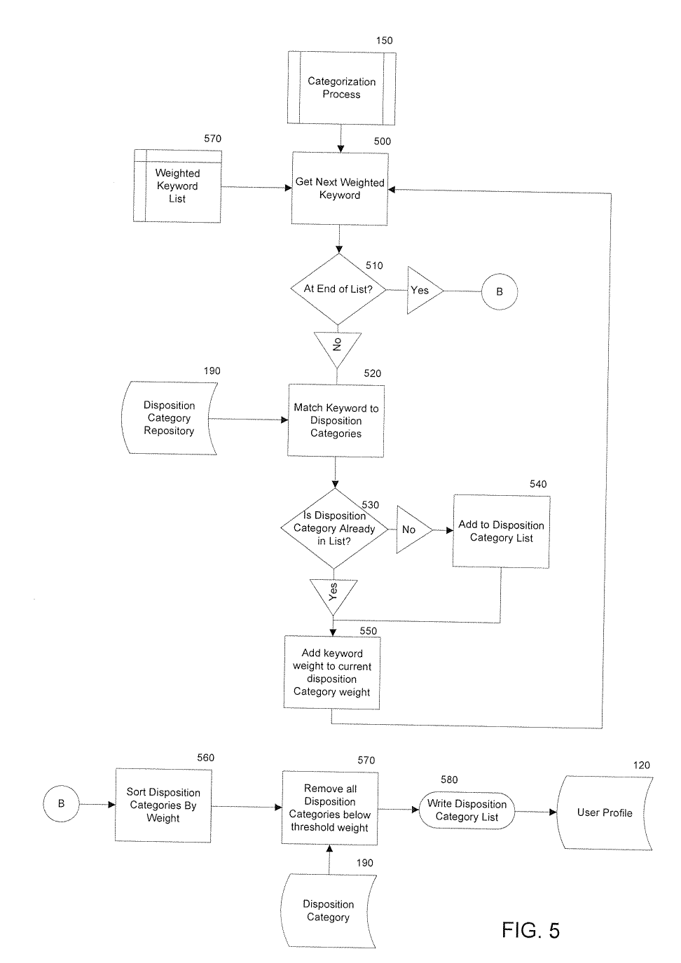

Described further in FIG. 5, the categorization process 150 is operable to match the prioritized list of keywords with one or more disposition categories 190. As keywords are matched with disposition categories, disposition category weights adjust. Disposition category weights are preferably stored in a data structure or file, and represent the sum total of aggregate keyword scores, for a given set of keywords included in a given disposition category. Disposition category weights tally to determine at least one most relevant disposition category, which the categorization process 150 stores to the user profile 120.

FIG. 1 shows the user profile 120, which is preferably a digital file or storage medium of a know sort adapted with a database of a known sort. The user profile 120 preferably includes a sequence of binary digits and/or a structured collection of data or records representing stored user specific information, including the user's unique disposition categories.

FIG. 2 shows the content generation engine 200, which is operable to request and serve topic content and advertisements to the user over a web browser. Invoked by the content request 210—a process executed to serve content to the user—the content generation engine preferably includes at least one content selection process 260, content prioritization process 270 and the content packager process 280. In the preferred embodiment, the user automatically invokes the content request 210 by adding or modifying content. Alternative embodiments invoke the request through batch processing, or commands issued by the administrator.

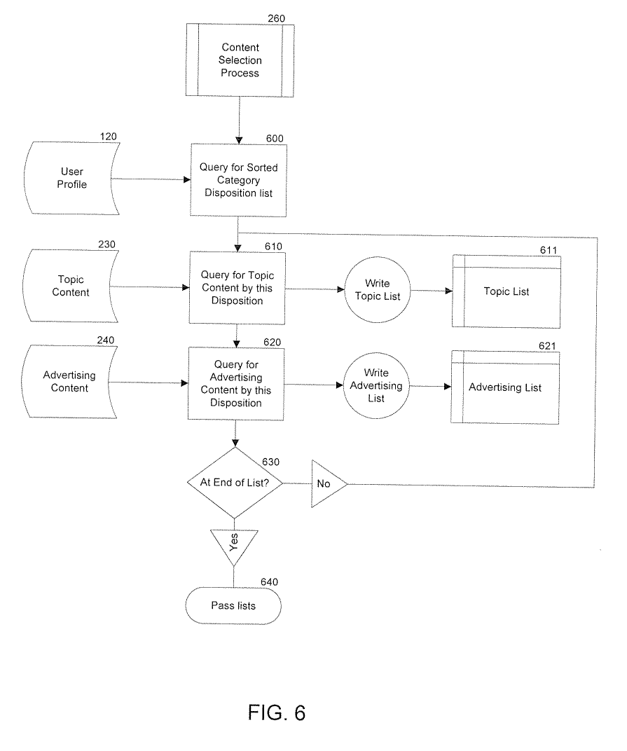

The content selection process 260 is operable to select topic content 230 and advertising content 240, based upon the unique user profile 120 created by the disposition engine 100. The content selection process 260 executes to match specific disposition categories stored in a user profile 120 with specific topic and advertising content, such content being stored in the topic content repository 230 and advertising content repository 240. Upon finding a positive match, the content selection process stores the content to a data structure or file, as further described in FIG. 6.

FIG. 2 shows the topic content repository 230 and advertising content repository 240. These repositories are preferably digital storage mediums operable with a database of a known sort.

Advertising content includes a variety of advertising media such as contextual ads, banner ads, streaming media commercials, emails, links to chat rooms, rich media, and hyperlinks, for example. Topic content includes materials pertaining to particular subjects such as a short article about a company's respective industry, or a biographical description and narrative from a professional, which include references and contact information for the author, for example. In the preferred embodiment, selected advertising content includes a hyperlink to the National Cancer Institute, and topic content includes a proton therapy article authored by leading oncologist in the user's geographic location, for example. Selected advertising and topic conent is stored to a file or data structure for further processing by other processes in the content generation engine 200.

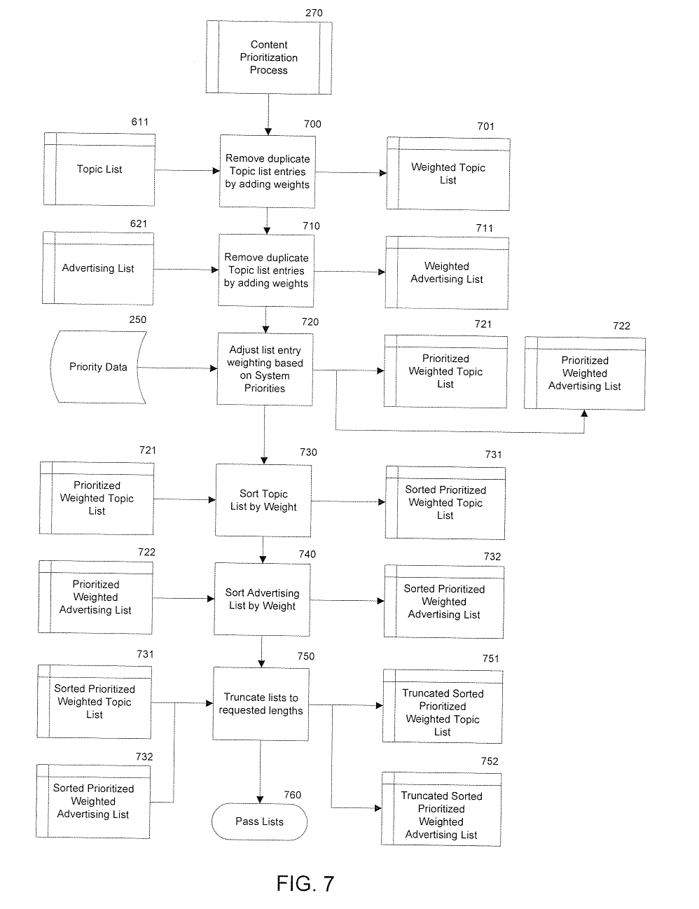

FIG. 2 shows the content prioritization process 270, which is a process operable to receive selected content from the content selection process 260. Based upon data stored in the priority data repository 250, the content prioritization process 270 executes to prioritize the selected topic and advertising content based on a plurality of criteria (See FIG. 7).

Priority data defines a preferred relative ordering of the content. Content with greater precedence or importance is identified accordingly in the priority data. The priority data is stored in the priority data repository 250, which is preferably a digital storage medium adapted with a database of a known sort. In the preferred embodiment, priority data includes the quality and state of servable content, date, proximity of content provider to user, advertiser or provider ranking, and discretion (e.g. taste) of the forum administrator, for example. Priority data also includes customer bids for content, quality of servable content (e.g., richness), desired dispersion of topics, locality of user relative to providers and advertisers, for example.

Once content is prioritized, the content packager 280 is preferably invoked. Shown in FIG. 2, the content packager 280 is a process operable to create a unique content package for the web server 220. The content package for the web server 220 comprises a content file and associated metadata for display to the user. Users view the content package 220 when accessing the online forum. In alternative embodiments, the user receives the content package 220 over email, text messages, telephones calls, handhelds and other known manners of advertisement. By cooperation of the above mentioned system processes, the content package 220 is organized to include highly relevant topic and advertising content direct to the specialized interests of the user.

User treatment of the packaged content is also observed by the content packager process 280. To that end, the content packager process 280 is operable to monitor and collect feedback information from the user regarding the user's response(s) to packaged content. Accordingly, the content packager process 280 is operable to analyze the feedback information, storing the information as usage statistics 290 and forwarding specific information to appropriate system processes. Feedback information relevant to the user's interests is preferably stored to the user activity and affinity repository, thereby providing input to the weighting process in further processing, for example. Accounting and invoicing information, such as clicks, cost per click, visits, cost per visit, click-through rates, and evidence of click fraud, are also collected and stored as usage statistics and forwarded by the content packager process 280.

FIG. 3 provides an example flow chart of the scraper process 130. As shown in FIG. 3, the scraper process 130 collects and continues to collect the segments of user content 300 from different user created content 160. Collecting includes active extraction from content sources, or passively receiving and continually receiving such content. Until the end of the user content 310 is reached, the scraper process queries the keyword repository 170 looking up keywords 320 that appear in the collected user created content. If the keywords are stored 330 (e.g., a match exists) the scraper process adds the keywords to the keyword list 340. If the collected content does not match a stored keyword, the scraper process collects the next segment of user content 300 and the analysis repeats. When the scraper process reaches the end of the user created content 310, it passes the keyword list 350 to the weighting process 140.

FIG. 4 shows an example flow chart for the weighting process 140. As shown in FIG. 4, the weighting process 140 gets keywords and continues to get the next keywords to weight 400 from the keyword list 470, until reaching the end of the list 410. The weighting process systematically looks up each keyword's weight 420 from the keyword repository 170, where the weights are stored. If the keyword's weight is not already in the weighted keyword list 430, it is added to the weighted keyword list 450. For keywords already in the keyword list, the weighting process adds weight to the current keyword weight 440. It is noted that weights may be negative for keywords having negative correlation. The process repeats until all the keywords' weights have been looked up and added to the weighted keyword list.

As shown in FIG. 4, keyword weights also adjust based upon the user's activities and affinities. Accordingly, the weighting process 140 continuously gets keywords from the weighted keyword list 470, until reaching the end of the keyword list 470, looking up each of such keywords 480 in the user activity and affinity repository 180, and determining if the keyword matches data stored in the user activity and affinity repository 180. If a match is made 490, the aggregate score for the keyword weight is adjusted 491 accordingly. The process repeats until all of the user activities and affinities have been considered and weights are updated in the weighted keyword list, at which point the weighted keyword list is passed 492.

FIG. 5 shows an example flow chart for the categorization process 150, which receives the weighted keyword list 570 and executes to create a unique user profile 120. In doing so, the categorization process 150 gets weighted keywords and continues to get the next weighted keywords 500 from the weighted keyword list 570 until reaching the end of the list 510. In a systematic manner, the categorization process queries the disposition category repository 190 to match each keyword to a specific disposition category 520. If a match exists 530, the categorization process adds the disposition category to the disposition category list 540 and stores the keyword weight to the disposition category weight. If a match exists, and the disposition is already in the list 530, the keyword weight is added to the current disposition category weight 550. The process repeats until the end of the weighted keyword list 510 is reached.

Upon reaching the end of the list 510, the categorization process sorts the disposition categories by weight 560. Disposition categories having greater weights are given priority, and all dispositions categories with weights below a threshold weight are removed 570 from the disposition category list. Disposition categories above and below the threshold are stored in the disposition category repository 190. However, preferably only those disposition categories above the threshold are stored/written to the disposition list 580 included in the user profile 120.

FIG. 6 shows a flow chart for the content selection process 260. Based upon the user profile 120, topic content 230, and advertising content 240, the content selection process creates a topic list 611 and advertising list 621 in the following manner. The content selection process 260 executes a query to get the user's list disposition categories 600, which are pre-sorted and stored to the user profile 120. In a systematic manner, the content selection process executes a query for specific topic content 610 in the topic content repository 230, for each disposition category stored in the user profile 120. Topic content matching the user's disposition categories is written to the topic list. The content selection process also executes a query 620 to lookups advertising content in the advertising content repository 240, for each of the user disposition categories stored in the user profile 120. Advertising content matching the disposition categories is written to the advertising list. The process repeats until reaching the end of the list 630, when the advertising and topic lists pass 640 to the content prioritization process.

FIG. 7 shows an example flow chart for the content prioritization process 270, which executes to prioritize the topic and advertising content. As shown in FIG. 7, the content prioritization process removes duplicate topic lists entries 700 from the topic list 611 by adding weights. That is, the content prioritization process 270 assigns a weighting to topics appearing multiple times in the topic list 611 so that such topics take priority over others. For example, the content selection process 260 (FIG. 6) may determine a topic is relevant to more than one disposition category stored to the user's profile. Accordingly, the topic will appear more than one time in the topic list 611. Adding weights to the duplicate topic enables it to take priority over other less relevant topics. The content prioritization process also removes duplicate advertising list entries by adding weights 710 from advertising list 621. As with duplicate topics, advertising content appearing more than one time in the advertising list 621 take priority over less relevant alternatives. Weighted topic content and weighted advertising content are stored in the weighted topic list 701 and weighted advertising list 711, respectively.

To prioritize the weighted content lists, the content prioritization process 270 adjusts topic and content list entries based upon system priorities 720. System priorities are made up of information stored in the priority data repository 250, which the content prioritization process 270 queries and accounts for to create the prioritized weighted topic list 721 and prioritized weighted advertising list 722. Next, the prioritized weighted topic list 721 is sorted by weight 730 to create a sorted prioritized weighted topic list 731. The prioritized weighted advertising list 722 is also sorted by weight 740 to create a sorted prioritized weighted advertising list 732. For improved layout on the user's web browser, the content prioritization process next truncates the lists (731 and 732) to requested lengths 750 and passes the lists 760 to the content packager 280.

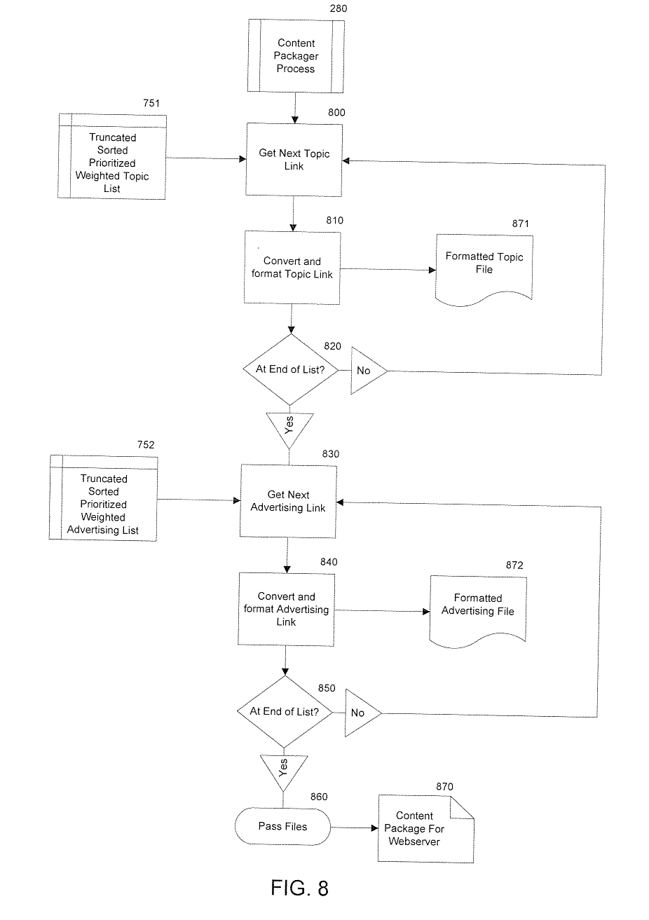

FIG. 8 shows an example flow chart for the content packager 280. As shown in FIG. 8, the content packager 280 processes the truncated sorted prioritized weighted topic list 751 by systematically getting the next topic link 800 in the list, and converting and formatting the topic link 810 for storage in a formatted topic file 871. The process repeats until reaching the end of the list 820. In sequence, the content packager process 280 also gets the next advertising link 830 from the truncated sorted prioritized weighted advertising list 752, converting and formatting the advertising link 840 for storage in the formatted topic file 872 until reaching the end of the list 850. At which point, the content packager 280 passes the files 860 to the content package web server 870.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A system comprising:
a scraper process operable to receive and continually receive user-input and determine matches to words stored in a keyword repository;
a weighting process operable to determine a weighting for each matched word and generate a prioritized list of weighted words; and
a categorization process operable to match the weighted words in the prioritized list to a plurality of dispositions categories and determine at least one most relevant disposition category.

2. The system of claim 1, further comprising:
a content selection process operable to select topic and advertising in response to the determined at least one most relevant disposition;
a content prioritization process operable to sort the selected topic and advertising by weighting; and
a content packager operable to generate a topic file and an advertising file in response to the prioritized topic and advertising.

3. The system of claim 1 wherein said user-input comprises at least one uniform code or uniform term.

4. The system of claim 3 wherein said uniform code or uniform term is a medical diagnostic code or medical term.

5. The system of claim 1 wherein said user-input is supplied to an online community, said online community organized according to healthcare related circumstances.

6. The system of claim 5 wherein said weighting process is based at least in part upon the context of the user-input within said online community.

7. The system of claim 6 wherein the context of the user-input includes the relative ordering of at least two of said matched words.

8. The system of claim 1 wherein said disposition categories comprise a set of uniform codes or uniform terms stored in said keyword repository.

9. A method comprising:
receiving user-input and determining matches to words stored in a keyword repository;
determining a weighting for each matched word and generating a prioritized list of weighted words;
matching the weighted words in the prioritized list to a plurality of disposition categories and determining at least one most relevant disposition category;
selecting topic and advertising in response to the determined at least one most relevant disposition category;
sorting the selected topic and advertising by weighting; and
generating a topic file and an advertising file in response to the prioritized topic and advertising.

10. The method of claim 9 wherein said step of receiving comprises receiving at least one uniform code or uniform term.

11. The method of claim 10 wherein said step of receiving at least one uniform code or uniform term comprises receiving at least one medical diagnostic code or medical term.

12. The method of claim 11 wherein said step of determining at least one most relevant disposition category comprises matching at least one received diagnostic code or medical term stored within said most relevant disposition category with at least one word stored in said keyword repository.

13. The method of claim 9 wherein said step of selecting topic and advertising comprises selecting at least one healthcare related topic and advertising.
